(19) United States
(12) Patent Application Publication
(10) Pub. No.: US 2024/0125986 A1
(43) Pub. Date: Apr. 18, 2024

(54) MEMBER FOR TERAHERTZ EQUIPMENT

(71) Applicant: NGK INSULATORS, LTD., Nagoya-shi (JP)

(72) Inventors: Kentaro TANI, Miyoshi-shi (JP); Jungo KONDO, Nagoya-shi (JP); Masahiko NAMERIKAWA, Nagoya-shi (JP); Yoshio KIKUCHI, Nagoya-shi (JP)

(21) Appl. No.: 18/536,342

(22) Filed: Dec. 12, 2023

Related U.S. Application Data
(63) Continuation of application No. PCT/JP2022/001401, filed on Jan. 17, 2022.

(30) Foreign Application Priority Data
Jun. 18, 2021 (JP) 2021-101361
Jul. 26, 2021 (JP) 2021-121400

(51) Int. Cl. G02B 5/18; G01N 21/3581

(52) U.S. Cl. CPC G02B 5/1861; G01N 21/3581

(57) ABSTRACT

A member for terahertz equipment includes: a substrate main body having a first principal surface and a second principal surface; and a reflection suppressing portion provided on at least one of the first principal surface or the second principal surface of the substrate main body. The reflection suppressing portion includes a plurality of protrusions which are arranged in a grating shape, and each have a tapered portion in a vertical cross section.

### CROSS-REFERENCE TO RELATED APPLICATIONS

This application is a continuation under 35 U.S.C. 120 of International Application PCT/JP2022/001401 having the International Filing Date of 17 Jan. 2022 and having the benefit of the earlier filing dates of Japanese Application No. 2021-101361, filed on 18 Jun. 2021 and Japanese Application No. 2021-121400, filed on 26 Jul. 2021. Each of the identified applications is fully incorporated herein by reference.

### BACKGROUND OF THE INVENTION

### 1. Field of the Invention

The present invention relates to a member for terahertz equipment.

### 2. Description of the Related Art

At present, development of a terahertz wave device (device that may radiate and/or detect terahertz waves) is in progress. The terahertz wave device (also referred to as “terahertz device” or “terahertz equipment” in some cases) is typically assumed to be used in terahertz wireless communication. The terahertz wireless communication is expected as a technology that may achieve short-range high-speed wireless communication. As uses of the terahertz wireless communication, for example, there can be given proximity data downloading (kiosk model), device-to-device communication, rack-to-rack communication in a data center, and communication for a mobile phone network. Further, the terahertz wave device is also expected to have applications to a body scanner, a pharmaceutical inspection, and the like. Various problems to be discussed are left toward practical use of the terahertz wave device.

### CITATION LIST

### Patent Literature

[PTL 1] WO 2021/070921 A1

### SUMMARY OF THE INVENTION

A principal object of the present invention is to provide a member for terahertz equipment with which a loss of terahertz waves to be caused by reflection is suppressed, and which is excellent in handleability.

A member for terahertz equipment according to an embodiment of the present invention includes: a substrate main body having a first principal surface and a second principal surface; and a reflection suppressing portion provided on at least one of the first principal surface or the second principal surface of the substrate main body. The reflection suppressing portion includes a plurality of protrusions which are arranged in a grating shape, and each have a tapered portion in a vertical cross section.

In one embodiment, each of the plurality of protrusions has a shape selected from a cone shape, a pyramid shape, a truncated cone shape, a truncated pyramid shape, a combination of a cylinder and a cone, a combination of a cylinder and a truncated cone, a combination of a prism and a pyramid, and a combination of a prism and a truncated pyramid.

In one embodiment, each of the plurality of protrusions in the reflection suppressing portion has a height of from 0.5 Ho (mm) to 2 Ho (mm), and the plurality of protrusions have a period of from 0.4 Ho (mm) to 1.3 Ho (mm),
where Ho is expressed by Expression: Ho=300/(f×√εr), in which “f” (GHz) represents a frequency of terahertz waves passing through the first principal surface, and “εr” represents a dielectric constant of the substrate main body.

In one embodiment, the substrate main body is made of a material selected from quartz glass, aluminum nitride, aluminum oxide, silicon carbide, magnesium oxide, spinel, and silicon.

In one embodiment, the substrate main body is made of quartz glass, and a porosity of the substrate main body regarding a pore size of 1 μm or more is from 0.5 ppm to 3,000 ppm.

In one embodiment, the substrate main body has a thickness of from 50 μm to 250 μm.

In one embodiment, the reflection suppressing portion is provided only on the first principal surface.

In one embodiment, the member further includes a terahertz element provided at a position corresponding to the reflection suppressing portion of the second principal surface of the substrate main body.

In one embodiment, a part in which the reflection suppressing portion is not provided of the first principal surface of the substrate main body has a reinforcing portion provided therein.

In one embodiment, the reinforcing portion has a thickness of from 0.5 Ho (mm) to 2 Ho (mm).

In one embodiment, the reinforcing portion is formed integrally with the substrate main body.

In one embodiment, the reinforcing portion is fixed to the substrate main body.

In one embodiment, the reinforcing portion is made of a material selected from quartz glass, silicon, alumina, copper, SUS, and brass.

In one embodiment, the reflection suppressing portion is provided only on the second principal surface, and the first principal surface has a convex portion provided thereon.

In one embodiment, the reflection suppressing portion is further provided on the convex portion.

In one embodiment, the reflection suppressing portion is provided only on the first principal surface, and the second principal surface has a concave portion formed therein.

In one embodiment, the reflection suppressing portion is further provided on the concave portion.

According to the embodiments of the present invention, it is possible to achieve the member for terahertz equipment with which the loss of terahertz waves to be caused by reflection is suppressed, and which is excellent in handleability.

### BRIEF DESCRIPTION OF THE DRAWINGS

FIG. 1 is a schematic plan view of a member for terahertz equipment according to one embodiment of the present invention.

FIG. 2 is a schematic sectional view taken along the line II-II of the member for terahertz equipment of FIG. 1.

FIG. 3 is a partial schematic sectional view for illustrating protrusions of a reflection suppressing portion in the member for terahertz equipment according to the embodiment of the present invention.

FIG. 4A is a schematic sectional view for illustrating an example of a reinforcing portion that may be provided in the member for terahertz equipment according to the embodiment of the present invention, and FIG. 4B is a schematic sectional view for illustrating another example of the reinforcing portion.

FIG. 5A is a schematic sectional view of a member for terahertz equipment according to another embodiment of the present invention, FIG. 5B is a schematic sectional view of a member for terahertz equipment according to further another embodiment of the present invention, and FIG. 5C is a schematic sectional view for illustrating an example of a configuration in a case in which the member for terahertz equipment of FIG. 5A and an active element are used in combination with each other.

FIG. 6A is a schematic sectional view of a member for terahertz equipment according to further another embodiment of the present invention, FIG. 6B is a schematic sectional view of a member for terahertz equipment according to further another embodiment of the present invention, and FIG. 6C is a schematic sectional view for illustrating an example of a configuration in a case in which the member for terahertz equipment of FIG. 6A and an active element are used in combination with each other.

FIG. 7A is a main-part schematic sectional view for illustrating an example of a terahertz element that may be provided in the member for terahertz equipment according to the embodiment of the present invention, and FIG. 7B is a main-part schematic sectional view for illustrating an example of an active element which is a component of the terahertz element of FIG. 7A.

### DESCRIPTION OF THE EMBODIMENTS

Embodiments of the present invention are described below with reference to the drawings. However, the present invention is not limited to these embodiments. For ease of observation, the drawings are schematically illustrated, and, in some cases, ratios in longitudinal, lateral, and thickness directions, shapes, angles, numbers, and the like are different from actual ones.

A. Overall Configuration of Member for Terahertz Equipment

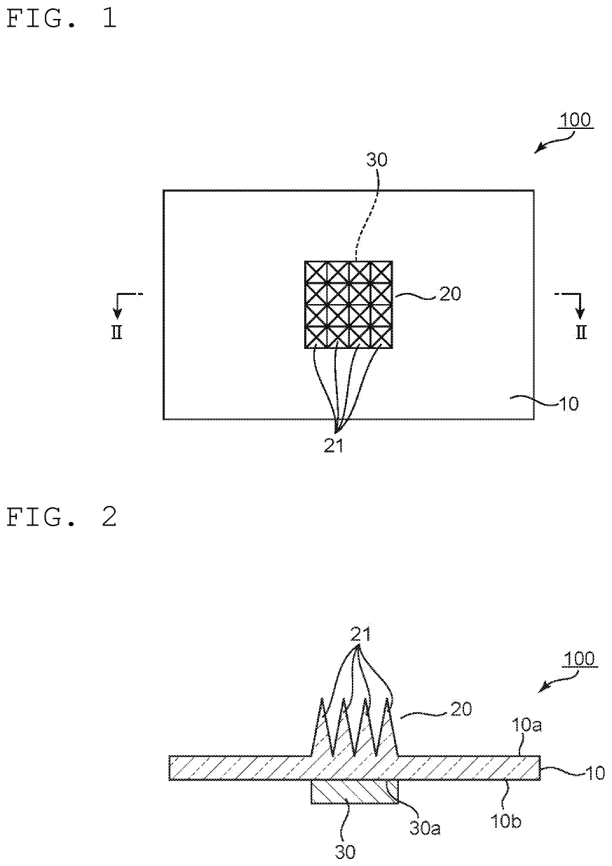

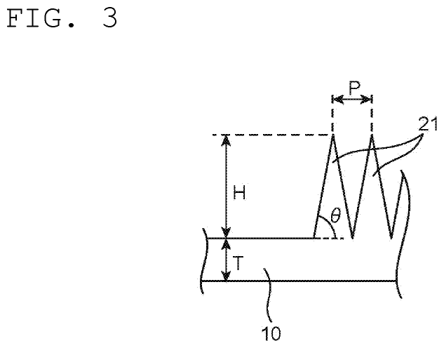

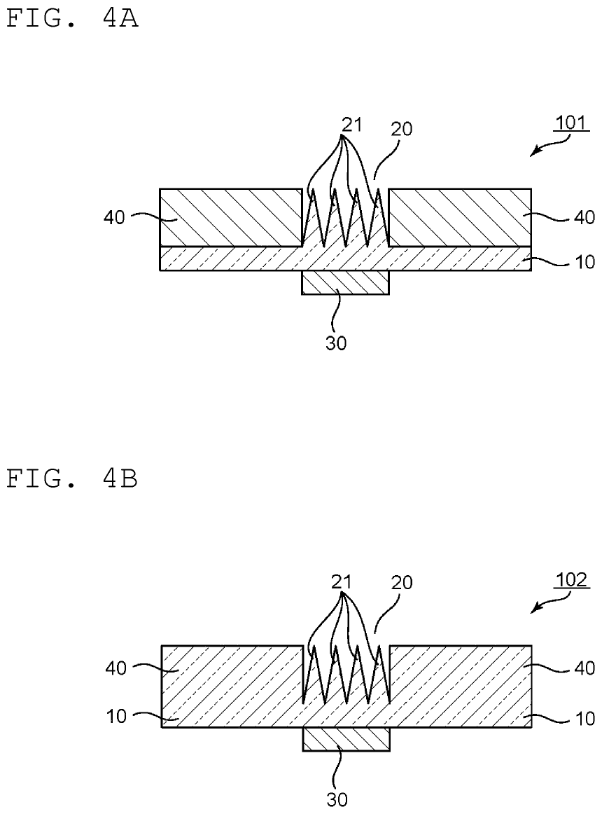

FIG. 1 is a schematic plan view of a member for terahertz equipment according to one embodiment of the present invention. FIG. 2 is a schematic sectional view taken along the line II-II of the member for terahertz equipment of FIG. 1. A member 100 for terahertz equipment in the illustrated example includes a substrate main body 10 and a reflection suppressing portion 20. The substrate main body 10 has a first principal surface 10a and a second principal surface 10b. The reflection suppressing portion 20 is provided on at least one of the first principal surface 10a or the second principal surface 10b of the substrate main body 10 (in the illustrated example, the reflection suppressing portion is provided on the first principal surface 10a). The reflection suppressing portion 20 may be provided at any appropriate position of the substrate main body 10 depending on the purpose (in the illustrated example, the reflection suppressing portion is provided at a center portion of the substrate main body). The reflection suppressing portion 20 may be formed integrally with the substrate main body 10, or may be mounted to the substrate main body 10 by any appropriate means. In the embodiment of the present invention, the reflection suppressing portion 20 includes a plurality of protrusions 21, 21, . . . arranged in a grating shape.

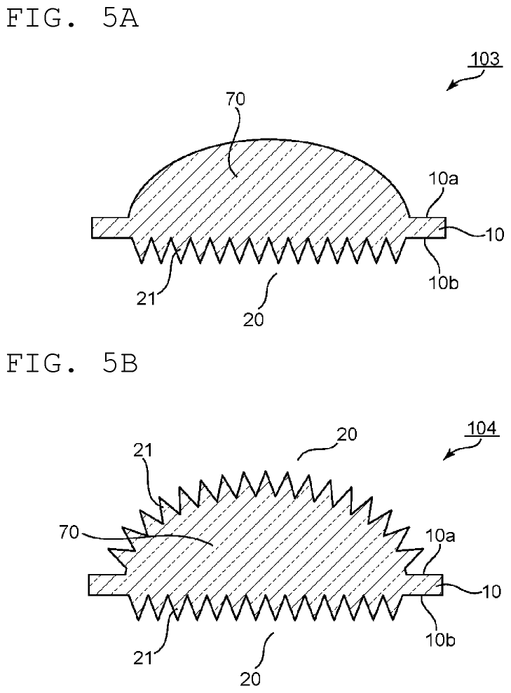

With such a configuration, a refractive index near the first principal surface (interface with air) of the substrate main body can be continuously changed, and hence a loss to be caused by reflection of terahertz waves oscillated and radiated from a terahertz element can be remarkably reduced. From the viewpoint of continuously changing the refractive index near the first principal surface (interface with air) of the substrate main body, the protrusion 21 includes a tapered portion in a vertical cross section. As illustrated in FIG. 3, the protrusion 21 may entirely have a tapered shape in the vertical cross section, or, although not shown, may partially have a tapered shape in the vertical cross section. Specifically, when the protrusion 21 entirely has the tapered shape in the vertical cross section, the protrusion 21 may have a cone shape, a pyramid shape (for example, a triangular pyramid shape, a quadrangular pyramid shape, a pentagonal pyramid shape, a hexagonal pyramid shape, a heptagonal pyramid shape, or an octagonal pyramid shape), a truncated cone shape, or a truncated pyramid shape. When the protrusion 21 partially has a tapered shape in the vertical cross section, the protrusion 21 may have a shape of, for example, a combination of a cylinder and a cone or a truncated cone, or a combination of a prism and a pyramid or a truncated pyramid. Further, the protrusion may have, other than the cone, the truncated cone, the prism, the truncated pyramid, or a combination of those shapes, for example, a round shape with a curvature in the vertical cross section. The illustrated example shows a mode in which the protrusion has a quadrangular pyramid shape. The protrusions preferably have the same shape. With such a configuration, the refractive index can be changed more smoothly. As the entire shape in plan view of the reflection suppressing portion, any appropriate shape may be adopted. As a specific example, there can be given a rectangular shape (illustrated example), a circular shape, an elliptical shape, and a polygonal shape.

The member for terahertz equipment may be manufactured by any appropriate method. For example, the member for terahertz equipment may be manufactured by cast molding or imprinting, or may be manufactured by cut-out or etching of a solid base material. Cast molding typically includes: preparing a forming mold including a protruding portion corresponding to the shape of the reflection suppressing portion; pouring a slurry containing raw material powder and a predetermined dispersant and dispersion medium into this forming mold; and curing and then firing the poured slurry inside the forming mold. When the member for terahertz equipment is manufactured as described above, silica or alumina is used as the raw material powder, and hence mixture of an OH group which may cause absorption of the terahertz waves can be suppressed as much as possible. In contrast, normal synthetic quartz glass uses a chloride-based silicon compound as a raw material. Thus, hydrolysis treatment is required during the manufacturing process, and an OH group remains. The synthetic quartz glass can have its OH group removed through plasma firing or reduction treatment through use of thionyl chloride or the like, but there arises a problem in that the material cost is increased. With cast molding, mixture of the OH group can be suppressed, a complicated substrate shape or lens shape can be adapted, and the reflection suppressing portion can be integrally formed. Thus, cast molding is a very good manufacturing method from the viewpoints of performance, mass production, and low cost. Cast molding can be performed in a procedure as described in, for example, WO 2018/100775 A1.

The member 100 for terahertz equipment may further include a terahertz element 30 depending on the purpose. For example, when the reflection suppressing portion 20 is provided on the first principal surface 10a of the substrate main body 10, the terahertz element 30 may be provided at a position corresponding to the reflection suppressing portion 20 of the second principal surface 10b of the substrate main body 10. The terahertz element 30 is typically provided so that one principal surface (back surface) 30a is opposed to the substrate main body 10. The terahertz element is an element for performing conversion between electrical energy and terahertz waves (electromagnetic waves having a frequency of from 0.1 THz to 10 THz). The terahertz element may convert the supplied electrical energy into terahertz waves through oscillation. In this manner, the terahertz element may radiate the terahertz waves. Meanwhile, the terahertz element may receive terahertz waves and convert the electromagnetic waves into electrical energy. In this manner, the terahertz element may detect the terahertz waves.

As used herein, a “position corresponding to” something refers to a state in which, when the member for terahertz equipment is observed in plan view, two members or components (in this case, the reflection suppressing portion 20 and the terahertz element 30) overlap each other. The reflection suppressing portion 20 and the terahertz element 30 may completely overlap each other, or partially overlap each other. The reflection suppressing portion 20 and the terahertz element 30 may have the same shape in plan view or different shapes in plan view. The reflection suppressing portion 20 and the terahertz element 30 preferably have the same shape in plan view. Further, the reflection suppressing portion 20 and the terahertz element 30 may have the same size in plan view, or one may have a size larger than that of the other. It is preferred that the size of the reflection suppressing portion 20 be larger than that of the terahertz element 30 in plan view. With such a configuration, the following advantages are provided. In general, electromagnetic waves generated from the terahertz element 30 propagate while spreading out. Further, in a waveguide, the electromagnetic waves spread out all over the waveguide. Accordingly, at a time point of reaching the reflection suppressing portion, an electric field distribution of the terahertz waves is larger than the terahertz element. Thus, the size in plan view of the reflection suppressing portion is set to be larger than the size in plan view of the terahertz element so that the loss to be caused by propagation and/or reflection of the terahertz waves oscillated and radiated from the terahertz element can be reduced. For example, the reflection suppressing portion may be provided on the entire first principal surface of the substrate main body, and the terahertz element may be provided at the center portion of the second principal surface.

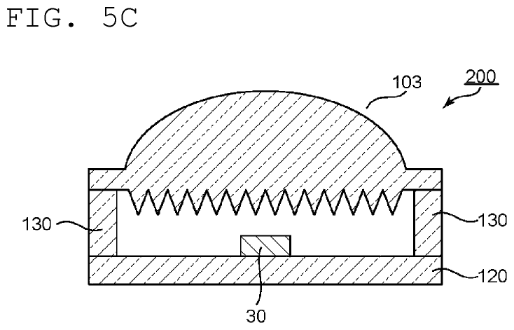

In one embodiment, as illustrated in FIG. 4A and FIG. 4B, the member for terahertz equipment may further include a reinforcing portion 40 in a part in which the reflection suppressing portion 20 is not provided of the first principal surface 10a of the substrate main body 10. Through provision of the reinforcing portion, the following effects may be provided. According to the embodiment of the present invention, the thickness of the substrate main body may be set to be very small (for example, about 100 μm as described later). With such a configuration, the loss to be caused by propagation and/or reflection of the terahertz waves oscillated and radiated from the terahertz element can be reduced. Meanwhile, when the thickness of the substrate main body is reduced, in some cases, the handleability of the entire member for terahertz equipment may become insufficient. Specifically, there may arise problems such as difficulty in maintaining the shape of the substrate main body, easy cracking of the substrate main body, insufficient mechanical strength, and difficulty in mounting to a terahertz equipment main body (substantially, to a casing). Through provision of the reinforcing portion, excellent handleability can be achieved while the effect obtained by thinning the substrate main body (suppression of the loss of the terahertz waves) is maintained, and the above-mentioned problems can be avoided.

The reinforcing portion 40 may be fixed to the substrate main body 10 as illustrated in FIG. 4A, or may be formed integrally with the substrate main body 10 as illustrated in FIG. 4B. When the reinforcing portion is fixed to the substrate main body, the fixing is performed by any appropriate means. For example, the reinforcing portion may be bonded to the substrate main body via an adhesive applied to the first principal surface of the substrate main body. As the fixing means other than the adhesive, for example, there can be given direct joining methods, such as a surface activation method, a plasma method, and an atomic diffusion method. When the reinforcing portion is formed integrally with the substrate main body, it is preferred that the entire member for terahertz equipment (substrate main body, reflection suppressing portion, and reinforcing portion) be manufactured by being cut out from a solid base material. In a member 102 for terahertz equipment illustrated in FIG. 4B, the first principal surface of the substrate main body is not clearly present, but it is apparent for a person skilled in the art that this state has a technical meaning equivalent to the state in which “the reinforcing portion is provided on the first principal surface of the substrate main body.”

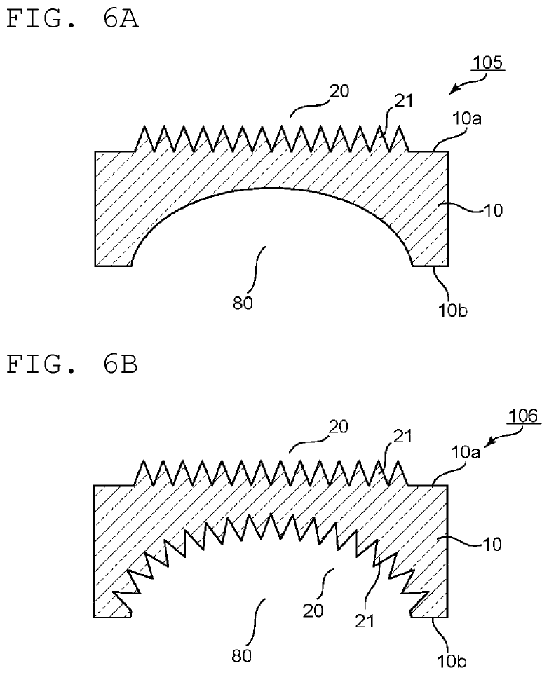

With reference to FIG. 5A to FIG. 5C, members for terahertz equipment according to other embodiments of the present invention are described. A member 103 for terahertz equipment of FIG. 5A has a convex portion 70 provided on the first principal surface 10a of the substrate main body 10. In this case, the reflection suppressing portion 20 is typically provided on the second principal surface 10b. A member 104 for terahertz equipment of FIG. 5B has the reflection suppressing portion 20 further provided on the convex portion 70 in addition to the second principal surface 10b. When the reflection suppressing portion is provided at two locations of the second principal surface and the convex portion, a more excellent reflection suppressing function can be achieved. The convex portion 70 may have a lens function with respect to the terahertz waves entering the terahertz element or exiting from the terahertz element. As a result, a propagation efficiency of the terahertz waves can be further improved. In the example illustrated in FIG. 5A, one convex portion 70 is provided on substantially the entire first principal surface 10a, and the reflection suppressing portion 20 is provided at a position corresponding to the convex portion 70 of the second principal surface 10b (in the illustrated example, substantially the entire surface). In the example illustrated in FIG. 5B, the reflection suppressing portion 20 is further provided on substantially the entire surface of the convex portion 70. Regions in which the convex portion 70 and the reflection suppressing portion 20 are provided are not limited to those in the illustrated example, and may be set as appropriate depending on the purpose. The member for terahertz equipment including such a convex portion can be suitably used as a lid member or a window member of a package on which the terahertz element is mounted. FIG. 5C is a schematic sectional view for illustrating an example of a configuration in a case in which the member for terahertz equipment of FIG. 5A and an active element are used in combination with each other. A terahertz element package 200 of the illustrated example includes any appropriate support member (for example, substrate) 120, the terahertz element 30 provided on the support member 120, and the member 103 for terahertz equipment integrated with the support member 120 through intermediation of a spacer portion 130. In the illustrated example, the member 103 for terahertz equipment is integrated with the support member 120 such that the reflection suppressing portion 20 and the terahertz element 30 are opposed to each other. Through adjustment of a height of the spacer portion 130, a size of a space in which the terahertz element 30 is arranged can be adjusted, and a distance between the terahertz element 30 and the reflection suppressing portion 20 can be adjusted. In this manner, the terahertz element can be arranged in accordance with a focal length of the lens, and highly-efficient light reception and radiation are allowed. The terahertz element package 200 may be integrally formed by any appropriate means. The terahertz element package 200 may be integrally molded (for example, formed by the above-mentioned cast molding) through use of a mold corresponding to the entire shape, or each component (substantially, the member for terahertz equipment, the support member, and the spacer portion) may be directly joined or caused to adhere. A contact surface of each component may be metallized. When the contact surface is metallized, each component may be joined by soldering. The support member and the spacer portion may typically be made of an inorganic material (for example, ceramics) or a metal. In one embodiment, the support member and the spacer portion may be made of the same material as that of the member for terahertz equipment. The constituent material of the member for terahertz equipment may be, as described later, for example, ceramics. When the member for terahertz equipment (thus, also the support member and the spacer portion) is made of ceramics, as compared to a case in which the member for terahertz equipment is made of an organic material (for example, a resin such as polypropylene (PP)), particularly excellent airtightness can be ensured. As a result, durability and reliability of the device can be improved. Further, ceramics have a dielectric constant larger than that of a resin, and hence when the convex portion having the same function is formed, the size of the convex portion can be reduced in the case of ceramics as compared to the case of a resin. As a result, the terahertz element package can be downsized. The shape of the convex portion may be set as appropriate depending on the purpose. As the shape of the convex portion, for example, there can be given a hemispherical shape and a semicircular column shape (semicylindrical shape). The number of the convex portions may be set as appropriate depending on the purpose and the shape and size of the convex portion. The size of the convex portion may be set as appropriate depending on the purpose and the shape and number of the convex portions. The illustrated example shows a configuration in which one convex portion (which may have a hemispherical shape or a semicircular column shape) is formed on the first principal surface, but the number of the convex portions may be two or more (for example, two, three, four, or more).

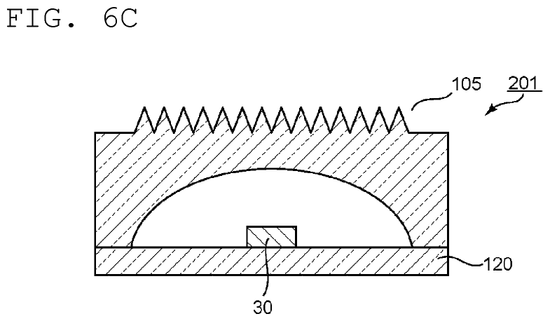

With reference to FIG. 6A to FIG. 6C, members for terahertz equipment according to further other embodiments of the present invention are described. A member 105 for terahertz equipment of FIG. 6A has a concave portion 80 formed in the second principal surface 10b of the substrate main body 10. In this case, the reflection suppressing portion 20 is typically provided on the first principal surface 10a. A member 106 for terahertz equipment of FIG. 6B has the reflection suppressing portion 20 further provided on the concave portion 80 in addition to the first principal surface 10a. When the reflection suppressing portion is provided at two locations of the first principal surface and the concave portion, a more excellent reflection suppressing function can be achieved. Similarly to the convex portion 70 illustrated in FIG. 5A to FIG. 5C, the concave portion 80 may have a lens function with respect to the terahertz waves entering the terahertz element or exiting from the terahertz element. As a result, a propagation efficiency of the terahertz waves can be further improved. In the example illustrated in FIG. 6A, one concave portion 80 is formed in substantially the entire second principal surface 10b, and the reflection suppressing portion 20 is provided at a position corresponding to the concave portion 80 of the first principal surface 10a (in the illustrated example, substantially the entire surface). In the example illustrated in FIG. 6B, the reflection suppressing portion 20 is further provided on substantially the entire surface of the concave portion 80. Regions in which the concave portion 80 and the reflection suppressing portion 20 are formed or provided are not limited to those in the illustrated example, and may be set as appropriate depending on the purpose. The member for terahertz equipment including such a concave portion can be suitably used as a lid member or a window member of a package on which the terahertz element is mounted. FIG. 6C is a schematic sectional view for illustrating an example of a configuration in a case in which the member for terahertz equipment of FIG. 6A and an active element are used in combination with each other. A terahertz element package 201 of the illustrated example includes any appropriate support member (for example, substrate) 120, the terahertz element 30 provided on the support member 120, and the member 105 for terahertz equipment integrated with the support member 120. In the illustrated example, the member 105 for terahertz equipment is integrated with the support member 120 such that the terahertz element 30 is stored in the concave portion 80. The terahertz element package 201 may be integrally formed by any appropriate means. The terahertz element package 201 may be integrally molded (for example, formed by the above-mentioned cast molding) through use of a mold corresponding to the entire shape, or each component (substantially, the member for terahertz equipment and the support member) may be directly joined or caused to adhere. A contact surface of each component may be metallized. When the contact surface is metallized, each component may be joined by soldering. The support member may typically be made of an inorganic material (for example, ceramics) or a metal. In one embodiment, the support member may be made of the same material as that of the member for terahertz equipment. The constituent material of the member for terahertz equipment and the effect obtained thereby are as described for the configurations of FIG. 5A to FIG. 5C. As the shape of the concave portion, for example, there can be given a hemispherical shape and a semicircular column shape (semicylindrical shape). The number of the concave portions may be set as appropriate depending on the purpose and the shape and size of the concave portion. The size of the concave portion may be set as appropriate depending on the purpose and the shape and number of the concave portions. The illustrated example shows a configuration in which one concave portion (which may have a hemispherical shape or a semicircular column shape) is formed on the second principal surface, but the number of the concave portions may be two or more (for example, two, three, four, or more).

Now, components of the member for terahertz equipment are specifically described.

B. Substrate Main Body

The substrate main body may be made of any appropriate material as long as the effect of the embodiment of the present invention can be obtained. As the constituent material of the substrate main body, for example, there can be given quartz glass, aluminum nitride (AlN), aluminum oxide (alumina: Al₂O₃), silicon carbide (SiC), magnesium oxide (MgO), spinel (MgAl₂O₄), and silicon. From the viewpoints of improving transparency and suppressing scattering, a crystal axis may be aligned in a direction parallel to an optical axis direction. Of those, quartz glass and alumina are preferred, and quartz glass is more preferred. When the constituent material is ceramics, the material is preferably polycrystalline or amorphous. With such a configuration, the anisotropic property can be eliminated, and hence a difference in loss depending on polarization and a propagation direction can be suppressed. Thus, the quartz glass may be amorphous or may be polycrystalline quartz.

A thickness of the substrate main body is, in the configurations illustrated in FIGS. 1 to 3 and FIGS. 4A and 4B for example, from 50 μm to 250 μm, preferably from 50 μm to 150 μm, more preferably from 70 μm to 130 μm, further preferably from 80 μm to 120 μm, particularly preferably from 90 μm to 110 μm. When the thickness of the substrate main body falls within the above-mentioned range, the loss to be caused by propagation and/or reflection of the terahertz waves oscillated and radiated from the terahertz element can be reduced. Further, the strength of the substrate main body can be ensured. The thickness of the substrate main body is, in the configurations illustrated in FIGS. 5A to 5C and FIGS. 6A to 6C, for example, from 250 μm to 3,000 μm, preferably from 300 μm to 2,000 μm, more preferably from 330 μm to 1,500 μm. The thickness of the substrate main body in the configurations illustrated in FIGS. 5A to 5C means a thickness from the second principal surface to a highest part of the convex portion, and the thickness of the substrate main body in the configurations illustrated in FIGS. 6A to 6C means a thickness from the first principal surface to the second principal surface. Thus, both of the thickness (height) of the convex portion and the recess (depth) of the concave portion may typically be expressed by a difference between the thickness of the substrate main body in the configurations illustrated in FIGS. 5A to 5C and FIGS. 6A to 6C and the thickness of the substrate main body in the configurations illustrated in FIGS. 1 to 3 and FIGS. 4A and 4B.

A porosity of the substrate main body regarding pores having pore sizes of 1 μm or more is preferably from 0.5 ppm to 3,000 ppm, more preferably from 0.5 ppm to 1,000 ppm, further preferably from 0.5 ppm to 100 ppm. When the porosity falls within the above-mentioned range, there are advantages in that densification is allowed, and scattering of the terahertz waves due to the pores and remaining of the OH group due to the pores are suppressed. The size of the pore refers to a diameter when the pore has a substantially sphere shape, refers to a diameter in a case of being observed in plan view when the pore has a substantially columnar shape, and refers to a diameter of a circle inscribed in the pore when the pore has other shapes. The presence or absence of the pores can be checked through use of, for example, optical computed tomography (CT) or a transmittance measuring instrument. The size of the pore can be measured through use of, for example, a scanning electron microscope (SEM).

An OH group of the substrate main body absorbs the terahertz waves, and hence it is preferred that the OH group of the substrate main body be reduced. The OH group of the substrate main body is preferably 100 ppm or less, more preferably 50 ppm or less, further preferably 20 ppm or less. As described above, when cast molding is used to form the substrate main body with quartz glass or alumina, the OH group can be reduced. Also, the OH group can be reduced when water-free glass is used.

Impurities are generally removed because the impurities may cause absorption in optical use. Meanwhile, in the substrate main body, each of Al, Fe, and Na may be mixed at a level of, by mass ratio, preferably 1,000 ppm or less, more preferably 10 ppm or less. It is considered that the mixture of the above-mentioned impurities may improve the sintering property, and thus contribute to achievement of a low dielectric constant and reduction of a dielectric loss of the terahertz waves.

Flattening treatment may be performed so that a surface roughness Ra of the substrate main body typically becomes several nanometers or less. With such a configuration, scattering of light or electromagnetic waves can be appropriately suppressed. The terahertz waves have a wavelength of from several tens of micrometers to several millimeters, and hence Ra may be from 5 nm to 0.5 μm. Further, Ra can be defined as an arithmetic average roughness in □10 μm and measured.

Flattening treatment may be performed so that recesses on the surface of the substrate main body typically become several nanometers or less. With such a configuration, scattering of light or electromagnetic waves can be appropriately suppressed. The terahertz waves have a wavelength of from several tens of micrometers to several millimeters. Thus, the width of the recess may be from 0.1 μm to 20 μm, and the depth thereof may be from 3 nm to 1 μm. The existence frequency may be from 5 thousand/mm 2 to 3 million/mm². Further, the width and the depth of the recess can be defined as an arithmetic average value in □30 μm, and can be measured through use of an atomic force microscope (AFM).

Quartz glass satisfying the above-mentioned characteristics may typically be manufactured by cast molding as described above. Such quartz glass may exhibit dielectric characteristics in 300 GHz of a dielectric constant of 3.8 and a dielectric loss (tan δ) of 0.001. In contrast, it is known that normal synthetic quartz glass (having the content of the OH group of typically 50 ppm or more) exhibits dielectric characteristics of the dielectric constant of 3.9 and the dielectric loss tan δ of 0.01. That is, the quartz glass to be used in the embodiment of the present invention can have a dielectric loss that is an order of magnitude smaller than that of the normal synthetic quartz glass.

A dielectric constant of the substrate main body in a range of from 100 GHz to 10 THz is preferably from 3.6 to 11.5, more preferably from 3.7 to 10.0, further preferably from 3.8 to 9.0. When the dielectric constant of the substrate main body falls within the above-mentioned range, there are advantages in that the substrate can be downsized and can be manufactured by machining or die molding, and the terahertz wave signal can be propagated without delay. When the dielectric constant is too small, the thickness of the substrate is required to be increased, and the height and/or the period of the protrusions of the reflection suppressing portion is required to be increased. As a result, the substrate size becomes too large, and, in some cases, there arises a problem in that a long period of time is required for machining or die molding. When the dielectric constant is too large, the thickness of the substrate is required to be decreased, and the height and/or the period of the protrusions of the reflection suppressing portion is required to be decreased. As a result, excessively fine processing is required, and, in some cases, it becomes difficult to manufacture the substrate by machining or die molding. Further, in some cases, there arises a problem in that the delay of the terahertz wave signal is increased. Moreover, the substrate main body having the dielectric constant as described above may exhibit a terahertz wave propagating characteristic that is remarkably better than that of a substrate main body made of a resin (having a dielectric constant of about 2.4).

A resistivity of the substrate main body is preferably 10 kΩ·cm or more, more preferably 100 kΩ·cm or more, further preferably 500 kΩ·cm or more, particularly preferably 700 kΩ·cm or more. When the resistivity falls within the above-mentioned range, the electromagnetic waves can propagate through the material with a low loss without affecting the electron conduction. This phenomenon has not become clear in detail, but it may be inferred that, when the resistivity is small, the electromagnetic waves couple with electrons so that the energy of the electromagnetic waves is taken through the electron conduction to cause a loss. From this viewpoint, it is preferred that the resistivity be as large as possible. The resistivity may be, for example, 3,000 kΩ (3 MΩ)·cm or less.

A dielectric loss (tan δ) of the substrate main body is, in the frequency to be used, preferably 0.01 or less, more preferably 0.008 or less, further preferably 0.006 or less, particularly preferably 0.004 or less. When the dielectric loss falls within the above-mentioned range, the propagation loss of the terahertz waves in the substrate main body can be reduced. It is preferred that the dielectric loss be as small as possible. The dielectric loss may be, for example, 0.001 or more. From this viewpoint, the quartz glass can reduce the dielectric loss very satisfactorily.

A bending strength of the substrate main body is preferably 50 MPa or more, more preferably 60 MPa or more. When the bending strength falls within the above-mentioned range, a handleability that is allowable even when the thickness of the substrate main body is reduced to about 100 μm can be ensured. It is preferred that the bending strength be as large as possible. The bending strength may be, for example, 700 MPa or less.

A coefficient of thermal expansion (coefficient of linear expansion) of the substrate main body is preferably 10×10⁻⁶/K or less, more preferably 8×10⁻⁶/K or less. When the coefficient of thermal expansion falls within the above-mentioned range, thermal deformation (typically, warpage) of the substrate main body (as a result, the entire member for terahertz equipment) can be satisfactorily suppressed.

A coefficient of water absorption of the substrate main body is preferably 0.008% or less, more preferably 0.007% or less, further preferably 0.005% or less. When the coefficient of water absorption of the substrate main body falls within the above-mentioned range, durability and reliability of the device can be improved. A lower limit of the coefficient of water absorption of the substrate main body may be, for example, 0.001%.

In the configurations illustrated in FIGS. 1 to 3 and FIGS. 4A and 4B, the substrate main body may have a power supply line (not shown) formed thereon. The power supply line is typically connected to the terahertz element. Thus, the power supply line may typically be formed on the second principal surface of the substrate main body. The power supply line may have any appropriate configuration. As the power supply line, for example, there can be given a coplanar line, a microstrip line, a strip line, and a slot line. In the configurations illustrated in FIGS. 5A to 5C and FIGS. 6A to 6C, the power supply line may typically be formed on the support member 120.

C. Reflection Suppressing Portion

The reflection suppressing portion may be made of the same material as or a different material from that of the substrate main body. The reflection suppressing portion is preferably made of the same material as that of the substrate main body. When the reflection suppressing portion and the substrate main body are made of the same material, an abrupt change in the refractive index from the substrate main body to the reflection suppressing portion can be suppressed, and the member for terahertz equipment can be easily manufactured at low cost.

The reflection suppressing portion includes, as described above, a plurality of protrusions arranged in a grating shape. As described above as well, the protrusion has a tapered portion in a vertical cross section. For example, as illustrated in FIG. 3, the protrusion may entirely have a tapered shape in the vertical cross section. Through adjustment of a height H, a period P, and a taper angle θ of the protrusions, the change in the refractive index near the first principal surface (interface with air) of the substrate main body can be controlled (typically, the refractive index can be continuously changed). As a result, the loss to be caused by reflection of the terahertz waves oscillated and radiated from the terahertz element can be remarkably reduced. As the reflection suppressing portion, for example, a configuration as described in JP 2013-130609 A may be adopted.

The height H of the protrusions is preferably from 0.5 Ho (mm) to 2 Ho (mm), and the period P of the protrusions is preferably from 0.4 Ho (mm) to 1.3 Ho (mm), where Ho is expressed by Expression: Ho=300/(f×√εr), in which “f” (GHz) represents a frequency of the terahertz waves passing through the first principal surface, and “εr” represents a dielectric constant of the substrate main body. In more detail, Ho is an index defined so that a reflection loss to be caused by the abrupt change of the refractive index can be sufficiently suppressed, and may be determined based on the magnitude of the wavelength of the electromagnetic waves effective with respect to the constituent material of the reflection suppressing portion. Specifically, when the frequency of the used electromagnetic waves is 300 GHz, and the constituent material of the reflection suppressing portion is quartz glass, the height of the protrusions is preferably from 250 μm to 750 μm, and the period of the protrusions is preferably from 200 μm to 650 μm. The height H of the protrusions is more preferably from 0.7 Ho (mm) to 1.3 Ho (mm), further preferably from 0.75 Ho (mm) to 1.25 Ho (mm), particularly preferably from 0.9 Ho (mm) to 1.1 Ho (mm). The period P of the protrusions is more preferably from 0.5 Ho (mm) to 1.35 Ho (mm), further preferably from 0.6 Ho (mm) to 1.3 Ho (mm), particularly preferably from 0.65 Ho (mm) to 1.25 Ho (mm). The taper angle θ is preferably from 45° to 70°, more preferably from 55° to 68°, further preferably from 60° to 65°. The number of the protrusions may be appropriately set depending on the purpose and the shape, period, and the like of the protrusions. In the illustrated example, sixteen protrusions in total, specifically, four protrusions in a first direction (for example, a longitudinal direction) and four protrusions in a second direction (for example, a lateral direction), are drawn. The number of protrusions in the first direction and the number of protrusions in the second direction may be the same or different from each other.

A ratio H/T of the height H of the protrusions of the reflection suppressing portion to a thickness T of the substrate main body is preferably from 1.6 to 9.4, more preferably from 2.7 to 8.0, further preferably from 3.1 to 6.0. When the ratio H/T falls within the above-mentioned range, the loss to be caused by reflection of the terahertz waves can be more satisfactorily suppressed.

D. Terahertz Element

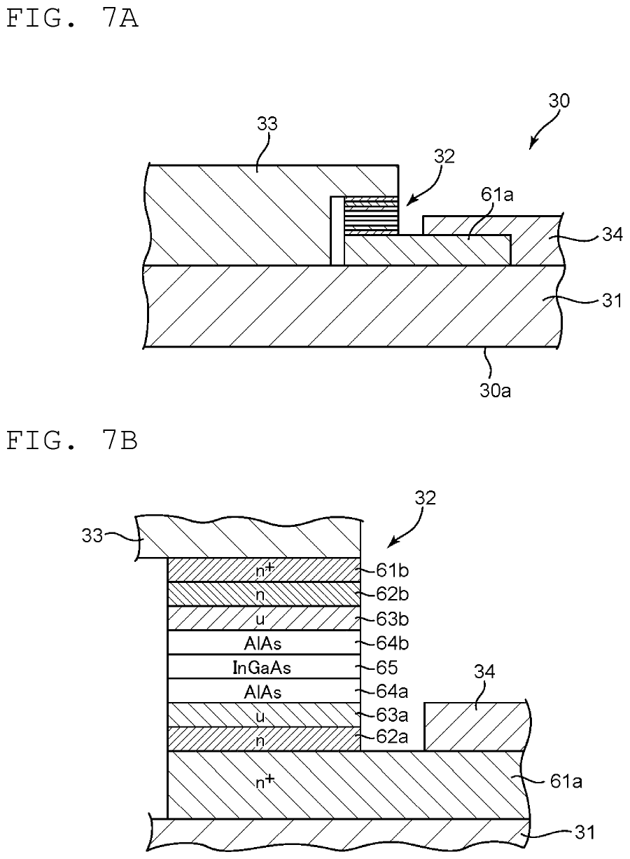

As the terahertz element, any appropriate configuration that may radiate and/or detect terahertz waves may be adopted. An outline of one example of the terahertz element is described with reference to FIG. 7A and FIG. 7B. Details of such a terahertz element are described in, for example, WO 2021/070921 A1. As the terahertz element, for example, configurations as described in WO 2020/110814 A1 and WO 2015/170425 A1 may be adopted.

The terahertz element 30 typically includes an element substrate 31, an active element 32, a first conductor layer 33, and a second conductor layer 34.

The element substrate 31 may be formed of any appropriate semiconductor. As a typical example of the semiconductor forming the element substrate, there can be given indium phosphide (InP) or silicon.

The active element 32 performs conversion between the terahertz waves and the electrical energy. As the active element, any appropriate configuration may be adopted. As specific examples of the active element, there can be given a resonant tunneling diode, a TUNNETT diode, an IMPATT diode, a GaAs-based field effect transistor, a GaN-based field effect transistor, a high electron mobility transistor, a heterojunction bipolar transistor, and a CMOS transistor. Now, an example of a specific configuration of the active element is described with reference to FIG. 7B.

On the element substrate 31, a semiconductor layer 61a is formed. The semiconductor layer 61a is made of, for example, GaInAs. The semiconductor layer 61a has n-type impurities doped therein at high concentration. On the semiconductor layer 61a, a GaInAs layer 62a is laminated. The GaInAs layer 62a has n-type impurities doped therein. On the GaInAs layer 62a, a GaInAs layer 63a is laminated. The GaInAs layer 63a is undoped with impurities.

On the GaInAs layer 63a, an AlAs layer 64a is laminated, and on the AlAs layer 64a, an InGaAs layer 65 is laminated. On the InGaAs layer 65, an AlAs layer 64b is laminated. The AlAs layer 64a, the InGaAs layer 65, and the AlAs layer 64b form a resonant tunneling unit.

On the AlAs layer 64b, a GaInAs layer 63b undoped with impurities is laminated. On the GaInAs layer 63b, a GaInAs layer 62b doped with n-type impurities is laminated. On the GaInAs layer 62b, a GaInAs layer 61b is laminated. The GaInAs layer 61b has n-type impurities doped therein at high concentration. For example, the impurity concentration of the GaInAs layer 61b is higher than the impurity concentration of the GaInAs layer 62b.

The first conductor layer 33 and the second conductor layer 34 may function as an antenna. Each of the first conductor layer 33 and the second conductor layer 34 is formed on one principal surface of the element substrate 31 (principal surface on the opposite side of the principal surface 30a on the substrate main body 10 side). The first conductor layer 33 and the second conductor layer 34 are insulated from each other. Each of the first conductor layer 33 and the second conductor layer 34 has a laminate structure of metals. As the laminate structure, for example, there can be given a laminate structure of gold (Au)/palladium (Pd)/titanium (Ti) and a laminate structure of Au/Ti.

E. Reinforcing Portion

As the reinforcing portion, any appropriate configuration may be adopted as long as the above-mentioned desired handleability may be applied. As described above, the reinforcing portion may be fixed to the substrate main body (FIG. 4A), or may be formed integrally with the substrate main body (FIG. 4B). In the configuration of FIG. 4A, the material for forming the reinforcing portion may be the same as or different from the material for forming the substrate main body. In this case, as the material for forming the reinforcing portion, for example, there can be given quartz glass, silicon, and alumina. Further, the material for forming the reinforcing portion may be copper, SUS, or brass to be used for a metal casing or a waveguide, and a deposited film or a plating film of gold or copper, which has a high conductivity, may be formed on a front surface or a side surface of the above-mentioned material. In the configuration of FIG. 4B, the material for forming the reinforcing portion is inevitably the same as the material for forming the substrate main body.

As the thickness of the reinforcing portion, any appropriate thickness may be set as long as the above-mentioned desired handleability may be applied. The thickness of the reinforcing portion is preferably from 0.5 Ho (mm) to 2 Ho (mm), more preferably from 0.7 Ho (mm) to 1.3 Ho (mm), further preferably from 0.75 Ho (mm) to 1.25 Ho (mm), particularly preferably from 0.9 Ho (mm) to 1.1 Ho (mm). Further, the thickness of the reinforcing portion is preferably equivalent to the height of the protrusions of the reflection suppressing portion. With such a configuration, the protrusion part can be prevented from hitting the waveguide at the time of mounting, and radiation of the terahertz waves to the outside along the reinforcing portion can be suppressed.

F. Terahertz Equipment

The member for terahertz equipment according to the embodiment of the present invention may be suitably used in the terahertz equipment. As the terahertz equipment, any appropriate configuration that may radiate and/or detect terahertz waves may be adopted. When the member for terahertz equipment according to the embodiment of the present invention includes the terahertz element, as the terahertz equipment, any appropriate configuration that can incorporate this member and cause this member to function may be adopted. A specific configuration of such terahertz equipment is described in, for example, WO 2021/070921 A1, JP 2017-143347 A, and JP 2012-49862 A. The descriptions of those patent literatures are incorporated herein by reference.

### EXAMPLE

Hereinafter, the present invention is specifically described by way of examples. However, the present invention is not limited by these examples.

### Example 1

A simulation was executed for a member for terahertz equipment having structure obtained by modifying FIG. 1 (specifically, structure in which the reflection suppressing portion was provided on the entire first principal surface of the substrate main body and the terahertz element was provided at the center portion of the second principal surface). The constituent material of the substrate main body and the reflection suppressing portion was quartz glass having a dielectric constant of 3.8 and a dielectric loss tan δ of 0.001. As the structure of the reflection suppressing portion, the height and the period of the protrusions were 0.51 mm and 0.41 mm, respectively. The simulation used an FDTD method. A reflection loss was calculated for frequencies of the terahertz waves of 250 GHz and 300 GHz with respect to each of incident angles of 30 degrees and 45 degrees assuming that the vertical incidence is 0 degrees. Results are shown in Table 1.

### Comparative Example 1

A simulation was executed for a member for terahertz equipment similar to that of Example 1 except that no reflection suppressing portion was provided. Results are shown in Table 1.

### Example 2

A simulation was executed similarly to Example 1 except that the constituent material was changed to alumina having a dielectric constant of 9 and a dielectric loss tan δ of 0.007, and the height and the period of the protrusions of the reflection suppressing portion were changed to 0.33 mm and 0.26 mm, respectively. Results are shown in Table 1.

### Comparative Example 2

A simulation was executed for a member for terahertz equipment similar to that of Example 2 except that no reflection suppressing portion was provided. Results are shown in Table 1.

TABLE 1

| | | | | Comparative | | | | Comparative | |
|---|---|---|---|---|---|---|---|---|---|
| | | Example 1 | | Example 1 | | Example 2 | | Example 2 | |
| Constituent material | | Quartz glass | | Quartz glass | | Alumina | | Alumina | |
| Reflection | Height H | 0.51 | | None | | 0.33 | | None | |
| suppressing | (mm) | | | | | | | | |
| portion | Period P | 0.41 | | | | 0.26 | | | |
| | (mm) | | | | | | | | |
| Frequency (GHz) | | 250 | 300 | 250 | 300 | 250 | 300 | 250 | 300 |
| Reflection | Incident | 8 | 8 | 8 | 20 | 1 | 1 | 1 | 8 |
| loss (%) | angle 0° | | | | | | | | |
| | Incident | 9 | 9 | 12 | 27 | 2 | 2 | 4 | 12 |
| | angle | | | | | | | | |
| | 30° | | | | | | | | |
| | Incident | 10 | 10 | 20 | 30 | 3 | 3 | 7 | 15 |
| | angle | | | | | | | | |
| | 45° | | | | | | | | |

| | | | | | | | | |
|---|---|---|---|---|---|---|---|---|
| Propagation loss (%) | 1 | 1 | 1 | 1 | 10 | 10 | 10 | 10 |
| Total loss (%) | 9 | 9 | 9 | 21 | 11 | 11 | 11 | 18 |
| (Incident angle 0°) | | | | | | | | |

### Example 3

A simulation was executed for the member for terahertz equipment having the structure of FIG. 5A. The constituent material of the substrate main body and the reflection suppressing portion was quartz glass having a dielectric constant of 3.8 and a dielectric loss tan δ of 0.001. As the structure of the reflection suppressing portion, the height and the period of the protrusions were 0.51 mm and 0.41 mm, respectively. The simulation used an FDTD method. The diameter of the convex portion was changed so that a relationship between the diameter of the convex portion and a focusing diameter of the terahertz waves was examined. As a terahertz light source, a resonant tunneling diode of 300 GHz was used. The focusing diameter was evaluated through use of TZcam manufactured by IR System Co., Ltd. The required focusing diameter was set to 1.1 mm. A lens diameter (diameter of the convex portion) required for achieving the focusing diameter of 1.1 mm was 3 mm.

### Comparative Example 3

A simulation was executed similarly to Example 3 except that the constituent material of the member for terahertz equipment (substantially, the substrate main body and the reflection suppressing portion) was changed from quartz glass to polypropylene (PP: dielectric constant of 2.4 and dielectric loss tan δ of 0.002). The lens diameter (diameter of the convex portion) required for achieving the focusing diameter of 1.1 mm was 3.6 mm.

As is apparent through comparison between Example 1 and Comparative Example 1 and between Example 2 and Comparative Example 2, through provision of the reflection suppressing portion, the member for terahertz equipment according to Examples of the present invention can remarkably suppress the reflection loss in a case in which high-frequency electromagnetic waves enter the member at a high incident angle, and can remarkably suppress the total loss of the high-frequency electromagnetic waves. Moreover, as is apparent through comparison between Example 1 and Example 2, quartz glass has a reflection loss larger than that of alumina, but a propagation loss of quartz glass is remarkably smaller. As a result, a total loss of quartz glass is smaller than that of alumina. The reason why the reflection loss of quartz glass is large is because reflection at an interface between the substrate main body and the terahertz element is large. Meanwhile, quartz glass has a dielectric loss remarkably smaller than that of alumina, and hence the propagation loss can be reduced.

Further, as is apparent through comparison between Example 3 and Comparative Example 3, when the same focusing diameter is to be achieved, through use of an inorganic material (quartz glass), the lens diameter (diameter of the convex portion) can be reduced by about 20% as compared to that of an organic material (PP). As a result, it can be understood that the terahertz element package can be downsized.

The member for terahertz equipment according to the embodiment of the present invention may be suitably used for the terahertz equipment. The terahertz equipment is expected to be applied to, for example, terahertz wireless communication, such as proximity data downloading (kiosk model), device-to-device communication, rack-to-rack communication in a data center, or communication for a mobile phone network, a body scanner, and a pharmaceutical inspection.

Many other modifications will be apparent to and be readily practiced by those skilled in the art without departing from the scope and spirit of the invention. It should therefore be understood that the scope of the appended claims is not intended to be limited by the details of the description but should rather be broadly construed.

What is claimed is:

1. A member for terahertz equipment, comprising:
a substrate main body having a first principal surface and a second principal surface; and
a reflection suppressing portion provided on at least one of the first principal surface or the second principal surface of the substrate main body,
wherein the reflection suppressing portion includes a plurality of protrusions which are arranged in a grating shape, and each have a tapered portion in a vertical cross section.

2. The member for terahertz equipment according to claim 1, wherein each of the plurality of protrusions has a shape selected from a cone shape, a pyramid shape, a truncated cone shape, a truncated pyramid shape, a combination of a cylinder and a cone, a combination of a cylinder and a truncated cone, a combination of a prism and a pyramid, and a combination of a prism and a truncated pyramid.

3. The member for terahertz equipment according to claim 1, wherein each of the plurality of protrusions in the reflection suppressing portion has a height of from 0.5 Ho (mm) to 2 Ho (mm), and the plurality of protrusions have a period of from 0.4 Ho (mm) to 1.3 Ho (mm),
where Ho is expressed by Expression: Ho=300/(f×√εr), in which “f” (GHz) represents a frequency of terahertz waves passing through the first principal surface, and “εr” represents a dielectric constant of the substrate main body.

4. The member for terahertz equipment according to claim 1, wherein the substrate main body is made of a material selected from quartz glass, aluminum nitride, aluminum oxide, silicon carbide, magnesium oxide, spinel, and silicon.

5. The member for terahertz equipment according to claim 1, wherein a porosity of the substrate main body regarding a pore size of 1 μm or more is from 0.5 ppm to 3,000 ppm.

6. The member for terahertz equipment according to claim 1, wherein an OH group of the substrate main body is preferably 100 ppm or less.

7. The member for terahertz equipment according to claim 5, wherein the substrate main body is made of quartz glass.

8. The member for terahertz equipment according to claim 6, wherein the substrate main body is a molded body of cast molding.

9. The member for terahertz equipment according to claim 8, wherein the substrate main body is made of quartz glass or aluminum oxide.

10. The member for terahertz equipment according to claim 1, wherein the substrate main body has a thickness of from 50 μm to 250 μm.

11. The member for terahertz equipment according to claim 1, wherein the reflection suppressing portion is provided only on the first principal surface.

12. The member for terahertz equipment according to claim 11, further comprising a terahertz element provided at a position corresponding to the reflection suppressing portion of the second principal surface of the substrate main body.

13. The member for terahertz equipment according to claim 11, wherein a part in which the reflection suppressing portion is not provided of the first principal surface of the substrate main body has a reinforcing portion provided therein.

14. The member for terahertz equipment according to claim 13, wherein the reinforcing portion has a thickness of from 0.5 Ho (mm) to 2 Ho (mm).

15. The member for terahertz equipment according to claim 13, wherein the reinforcing portion is formed integrally with the substrate main body.

16. The member for terahertz equipment according to claim 13, wherein the reinforcing portion is fixed to the substrate main body.

17. The member for terahertz equipment according to claim 16, wherein the reinforcing portion is made of a material selected from quartz glass, silicon, alumina, copper, SUS, and brass.

18. The member for terahertz equipment according to claim 1, wherein the reflection suppressing portion is provided only on the second principal surface, and the first principal surface has a convex portion provided thereon.

19. The member for terahertz equipment according to claim 18, wherein the reflection suppressing portion is further provided on the convex portion.

20. The member for terahertz equipment according to claim 1, wherein the reflection suppressing portion is provided only on the first principal surface, and the second principal surface has a concave portion formed therein.

21. The member for terahertz equipment according to claim 20, wherein the reflection suppressing portion is further provided on the concave portion.
